(19) United States
(12) Patent Application Publication
(10) Pub. No.: US 2015/0242108 A1
(43) Pub. Date: Aug. 27, 2015

(54) METHOD AND APPARATUS FOR DISPLAYING CONTENT USING PROXIMITY INFORMATION

(71) Applicant: SAMSUNG ELECTRONICS CO., LTD., Suwon-si (KR)

(72) Inventors: Do-Hyeon KIM, Suwon-si (KR); Ho-Young JUNG, Suwon-si (KR); Won-hee LEE, Cheongju-si (KR); Jae-woong LEE, Bucheon-si (KR)

(73) Assignee: SAMSUNG ELECTRONICS CO., LTD., Suwon-si (KR)

(21) Appl. No.: 14/629,763

(22) Filed: Feb. 24, 2015

(30) Foreign Application Priority Data
Feb. 24, 2014 (KR) 10-2014-0021525
Oct. 6, 2014 (KR) 10-2014-0134477

(51) Int. Cl. G06F 3/0484; G06F 3/041

(52) U.S. Cl. CPC G06F 3/04847; G06F 3/041; G06F 3/04842

(57) ABSTRACT

A terminal for providing content intuitively and a method of displaying content, which is performed by the terminal, are provided. The method includes: displaying first content on a display; obtaining proximity information related to a proximity of an input tool to the first content displayed on the display; and displaying second content on an area of the first content based on the proximity information.

### RELATED APPLICATIONS

This application claims the benefit of Korean Patent Application No. 10-2014-0021525, filed on Feb. 24, 2014, and Korean Patent Application No. 10-2014-0134477, filed on Oct. 6, 2014, in the Korean Intellectual Property Office, the disclosures of which are incorporated herein in their entireties by reference.

### BACKGROUND

1. Field

One or more exemplary embodiments relate to a terminal that may provide content intuitively and a method of controlling the terminal, where the terminal and the method utilize proximity information to provide the content.

2. Description of the Related Art

As communication technologies have advanced and electronic devices have gotten smaller, mobile terminals have been widely supplied to general consumers. Particularly, recently, personal terminals, such as smartphones or smart tablets, have been widely supplied.

A terminal may include a display device. The display device may be, for example, a touchscreen. The display device may perform both a function of displaying content and a function of receiving a user input. For example, a touchscreen may perform both a function of receiving a touch input by a user and a function of displaying a screen of information.

A user of a terminal may control the terminal by using a finger or an input tool, and the user may input information by using a finger or an input tool. The terminal may display a screen of information or play sound according to information received from the user.

### SUMMARY

One or more exemplary embodiments include a terminal that may provide content intuitively and a method of controlling the terminal.

One or more exemplary embodiments include a terminal that may display a screen or play sound according to a simple manipulation, and a method of controlling the terminal.

Additional aspects will be set forth in part in the description which follows and, in part, will be apparent from the description, or may be learned by practice of the presented exemplary embodiments.

According to one or more exemplary embodiments, a terminal includes: an input unit configured to obtain proximity information related to a proximity of an input tool to first content displayed on the terminal; a controller configured to control a display to display second content on an area of the first content, based on the proximity information; and the display configured to display the first content and the second content, based on the proximity information.

The controller is configured to may determine whether the input tool is located within a range of distance from the display and is configured to control the display to display the second content on the area of the first content based on the determination of whether the input tool is located within the range of distance from the display.

The proximity information may include information related to a location of the input tool, and wherein the controller is configured to control the display to display the second content on an area of the first content, based on the location of the input tool.

The proximity information may further include information related to a degree of proximity of the input tool to the terminal, wherein the controller is configured to control the display to display the second content on the area of the first content based on the information related to the degree of the proximity.

The controller is configured to select the second content from among a plurality of pieces of content, based on the information related to the degree of the proximity.

The controller is configured to compare an amount of a change in the location of the input tool for a period of time to a reference value, based on the proximity information, and is configured to control the display to display third content on the area of the first content, based on a result of the comparing the amount of the change in the location of the input tool for the period of time to the reference value.

The first, second, and third content may respectively include at least one from among a text, a drawing, a picture, and a video clip.

The controller is configured to control the display to display third content on another area of the first content, based on input information received from the input tool.

The input unit is configured to detect a touch input by the input tool, and the controller is configured to control the display to display third content in another area of the first content, according to the touch input.

The information related to the location of the input tool may include information related to a location of a point at which a straight line extending in a perpendicular direction from an end of the input unit to the display meets a surface of the display, and the controller is configured to control the display by using the information related to the location of the point at which the straight line extending in the perpendicular direction from the end of the input unit to the display unit meets the surface of the display unit and the information related to the degree of proximity of the input tool to the terminal.

The terminal may further include a speaker configured to play sound, the controller is configured to control the speaker by using the proximity information.

According to one or more exemplary embodiments, there is provided a method of displaying content, the method being performed by a terminal, includes: displaying first content on a display; obtaining proximity information related to a proximity of an input tool to the first content displayed on the display unit; and displaying second content on an area of the first content based on the proximity information.

The displaying the second content may include determining whether the input tool is located within a range of distance from the display; and displaying the second content in the area of the first content based on the determination of whether the input tool is located within the range of distance from the display.

The proximity information may include information related to a location of the input tool, and the displaying the second content includes displaying the second content to overlap with the first content in the area of the first content, based on the location of the input tool.

The proximity information may further includes information related to a degree of proximity of the input tool to the terminal, and the displaying the second content may include displaying the second content to overlap with the first content in the area of the first content, based on the information related to the degree of the proximity.

The displaying the second content may further include selecting the second content from among a plurality of pieces of content, based on the information related to the degree of the proximity.

The displaying the second content may further include comparing an amount of a change in the location of the input tool for a period of time to a reference value, based on the proximity information; and displaying third content on another area of the first content, based on a result of the comparing.

The first to third content may respectively include at least one from among a text, a drawing, a picture, and a video clip.

The displaying may further include: receiving input information from the input tool; and displaying third content on another area of the first content, based on the received input information.

The displaying may further include: detecting a touch input by the input tool, and displaying third content on another area of the first content, according to the touch input.

The information related to the location of the input tool may include information related to a location of a point at which a straight line extending in a perpendicular direction from an end of the input tool to the display meets a surface of the display, and the displaying the second content may further include displaying the second content on the area of the first content by using the information related to the location of the point at which a straight line extending in a perpendicular direction from the end of the input unit to the display unit meets a surface of the display and the information related to the degree of the proximity of the input tool to the terminal.

The method may further include controlling a speaker, included in the terminal, by using the proximity information.

According to one or more exemplary embodiments, a non-transitory computer-readable recording storage medium having stored thereon a computer program, which when executed by a computer, performs the method.

According to an aspect of an exemplary embodiment, the proximity information may include information related to a location of the input tool, and the controller may be configured to control the display to display the second content in a different area than the area of the first content.

The controller controls the display to only display the third content without displaying the first content. The first content, the second content, and the third content may be displayed together.

The first content displayed when the proximity information is obtained may be identical to content displayed before the proximity information is obtained.

The third content may be different from the first and the second content.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a block diagram of a configuration of a terminal according to an exemplary embodiment;

FIG. 2 illustrates a screen that is displayed on the terminal before an input is received from an input tool, according to an exemplary embodiment;

FIG. 3 illustrates a screen displayed on the terminal if the input tool is located within 5 cm of the terminal, according to an exemplary embodiment;

FIG. 4 illustrates a screen displayed on the terminal if the input tool is located within 3 cm of the terminal, according to an exemplary embodiment;

FIG. 5 illustrates a screen displayed on the terminal if the input tool is located within 1 cm of the terminal, according to an exemplary embodiment;

FIG. 6 illustrates a screen of the terminal on which additional content is further displayed in a pop-up form, according to an exemplary embodiment;

FIG. 7 illustrates a screen of the terminal on which a video clip is further displayed in a pop-up form, according to an exemplary embodiment;

FIG. 8 illustrates a screen of the terminal on which new content is displayed after additional content is displayed, according to an exemplary embodiment;

FIG. 9 is a flowchart of a process of performing the content displaying method, according to an exemplary embodiment;

FIG. 10 illustrates content formed of a plurality of layers, according to some exemplary embodiments;

FIG. 11 illustrates a screen on which content formed of a plurality of layers is displayed according to proximity information, according to some exemplary embodiments; and

FIG. 12 is a flowchart of a method of illustrating content formed of a plurality of layers according to proximity information, according to some exemplary embodiments.

### DETAILED DESCRIPTION

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects of the present description. The exemplary embodiments are provided so that this disclosure will be thorough and complete, and will fully convey the concept of the inventive concept to those skilled in the art, and the scope of the inventive concept should be defined by the appended claims. Like reference numerals in the drawings denote like elements, and thus their description will be omitted. As used herein, the term “and/or” includes any and all combinations of one or more of the associated listed items. Expressions such as “at least one of,” when preceding a list of elements, modify the entire list of elements and do not modify the individual elements of the list.

While such terms as “first”, “second”, etc., may be used to describe various components, such components must not be limited to the above terms. The above terms are used only to distinguish one component from another. Accordingly, a first element mentioned herein may be a second element, without departing from the scope of exemplary embodiments.

The terminology used herein is for the purpose of describing exemplary embodiments only and is not intended to be limiting of the inventive concept. As used herein, the singular forms are intended to include the plural forms as well, unless the context clearly indicates otherwise. It will be further understood that the terms “comprises” and/or “comprising”, when used in this specification, specify the presence of stated steps, operations, elements, and/or components, but do not preclude the presence or addition of one or more other steps, operations, elements, components, and/or groups thereof.

Unless otherwise defined, all terms used herein have the same meaning as commonly understood by one of ordinary skill in the art to which the inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

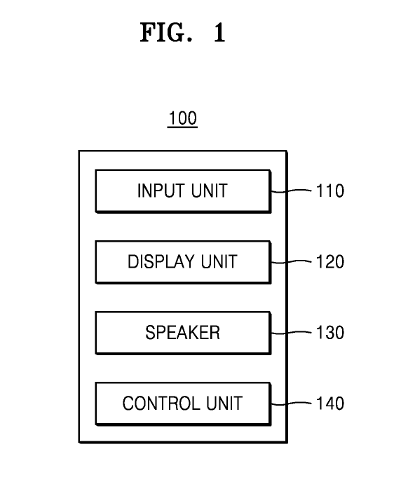

Hereinafter, a terminal and a method of controlling the terminal will be described in detail by explaining exemplary embodiments with reference to FIGS. 1 to 12.

FIG. 1 is a block diagram of a configuration of a terminal 100 according to an exemplary embodiment. The terminal 100 may be various electronic devices, for example, a laptop computer, a personal computer (PC), a smartphone, or a smart tablet. Referring to FIG. 1, the terminal 100 may include an input unit 110, a display unit 120 (e.g., display), a speaker 130, and a control unit 140 (e.g., controller).

According to some exemplary embodiments, the input unit 110, the display unit 120, the speaker 130, and the control unit 140 which are included in the terminal 100 may include one or more processors, and may be formed of hardware.

According to an exemplary embodiment, the input unit 110 may receive an input from an entity external to the terminal 100. The input unit 110 may receive a user input of the terminal 100. The input unit 110 may include various user interfaces, for example, a touchscreen or a touch pad. Additionally, according to an exemplary embodiment, the input unit 110 may receive an input from an input tool.

According to an exemplary embodiment, the input tool may be a pen that employs an electromagnetic resonance (EMR) method, such as an electronic pen or a stylus pen. Additionally, according to an exemplary embodiment, the input tool may be a part of a physical body of a user who uses the terminal 100. For example, the input tool may be a finger of the user.

According to an exemplary embodiment, the input unit 110 may include a touchscreen that employs the EMR method, so as to receive an input from an EMR pen. Additionally, according to an exemplary embodiment, the input tool may include at least one button, and thus receive a user input via the at least one button and transmit the received user input to the terminal 100 via the at least one button.

According to an exemplary embodiment, the input unit 110 may receive a touch input via the input tool. A user may touch a particular point on the display unit 120 included in the terminal 100 by using the input tool. Additionally, the input unit 110 may receive a button input from the input tool. Additionally, the input tool may receive a user input based on the user pushing a button included in the input tool or deactivating a push of the button.

Additionally, according to an exemplary embodiment, the input unit 110 may obtain proximity information of the input tool with respect to the terminal 100.

According to an exemplary embodiment, the proximity information may include information about whether the input tool is near the terminal 100. In other words, proximity information may include at least one selected from the group consisting of information about whether the input tool is located on the display unit 120 included in the terminal 100 and information about whether the input tool is located near the display unit 120 within a specific range of distance from the display unit 120.

According to an exemplary embodiment, the terminal 100 may detect whether the input tool is located within a specific distance range from the display unit 120 included in the terminal 100, and determine whether the input tool is near the terminal 100 based on a result of the detecting.

Additionally, according to an exemplary embodiment, proximity information may include information about a location of the input tool. In other words, proximity information may include information about a location of the input tool with respect to the terminal 100. For example, proximity information may include information about a three-dimensional (3D) coordinate of the input tool.

Additionally, according to an exemplary embodiment, proximity information may include information about a degree of proximity between the terminal 100 and the input tool. In other words, proximity information may include information about a degree in which the input tool is near the terminal 100. For example, the terminal 100 may detect whether the input tool is located within 3 cm of the terminal 100 or within 5 cm of the terminal 100, or both.

According to an exemplary embodiment, the display unit 120 may display a screen. In other words, the display unit 120 may display content. For example, a screen displayed by the display unit 120 may be a screen on which content such as a drawing, a picture, or a video clip is displayed. The display unit 120 may include a flat-panel display (FPD) device such as a liquid-crystal display (LCD) device, an organic light-emitting diode (OLED) device, or a plasma display panel (PDP). Additionally, the display unit 120 may include a curved display device or a flexible display device. The display unit 120 and the input unit 110 may be formed as one body or formed separately.

According to an exemplary embodiment, the display unit 120 may display first content and second content. In other words, the display unit 120 may display first content and second content based on proximity information. Additionally, the display unit 120 may further display third content, which is different from the first content and the second content.

According to an exemplary embodiment, a method of displaying content, which is performed by the display unit 120, is not limited. The display unit 120 may display the first content and the second content together, according to a control by the control unit 140. The display unit 120 may also display the second content on a particular area of the first content. Additionally, the display unit 120 may display the second content to overlap with the first content on a particular area of the first content.

According to an exemplary embodiment, the speaker 130 may play sound. The sound played by the speaker 130 may include audio content. For example, the sound may include a sound effect or music.

According to an exemplary embodiment, the control unit 140 may control the display unit 120 or the speaker 130 by using information obtained or detected by the input unit 110. For example, the control unit 140 may control the display unit 120 to display content or the speaker 130 to play sound, by using proximity information obtained, received, or detected by the input unit 110. The control unit 140 may be, for example, a central processing unit (CPU).

According to an exemplary embodiment, the control unit 140 may control the display unit to display the second content on a particular area of the first content based on proximity information that is information about whether the input tool is near the display unit 120. In other words, the control unit 140 may detect and determine whether the input tool is located within a specific range of distance from the display unit 120, and control the display unit 120 to display the second content on a particular area of the first content based on a result of the determination of whether the input tool is located within a specific range of distance from the display unit 120. For example, the control unit 140 may determine whether to display the second content on a particular area of the first content, according to whether the input tool is located within a specific range of distance from the display unit 120.

Additionally, according to an exemplary embodiment, the control unit 140 may control the display unit 120 to display the second content to overlap with a particular area of the first content based on a location of the input tool. For example, the control unit 140 may control the display unit 120 to display the second content to overlap with the first content in a particular area of the first content—the particular area may relate to a location at which a straight line extending in a perpendicular direction from an end of the input tool to the display unit 120 meets a surface of the display unit 120, or a location of the input tool.

According to an exemplary embodiment, the control unit 140 may control the display unit 120 to display content according to a degree of proximity of the input unit to the display unit 120.

In other words, according to an exemplary embodiment, the control unit 140 may select second content that is one of a plurality of pieces of content based on information about a degree of proximity, and control the display unit 120 to display the first content and the selected second content together or separately.

Additionally, according to an exemplary embodiment, based on proximity information of the input tool, if an amount of a change in a location of the input tool for a particular period of time is equal to or less than a particular amount of time, the control unit 140 may control the display unit 120 to display third content, which is different from the second content, on a particular area of the first content. According to an exemplary embodiment, the display unit 120 may display the third content to overlap with the first content. Alternatively, the display unit 120 may display only the third content without having to display the first content, or display the first content, the second content, and the third content together.

According to an exemplary embodiment, the control unit 140 may control the display unit 120 to display at least one selected from the group consisting of the first to third content, based on input information received form the input tool or a touch input by the input tool.

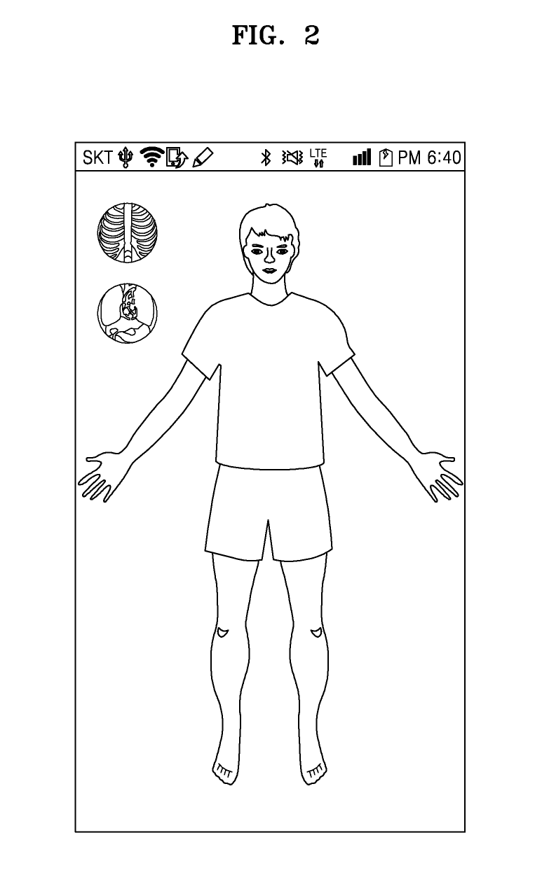

FIG. 2 illustrates a screen that is displayed on the terminal 100 before an input is received from an input tool, according to an exemplary embodiment.

According to an exemplary embodiment, the display unit 120 may display a screen as shown in FIG. 2, before information about a location of the input tool is detected by the input unit 110 or an input is received from the input tool. Referring to FIG. 2, the display unit 120 may display first content that is an image of a person wearing clothes.

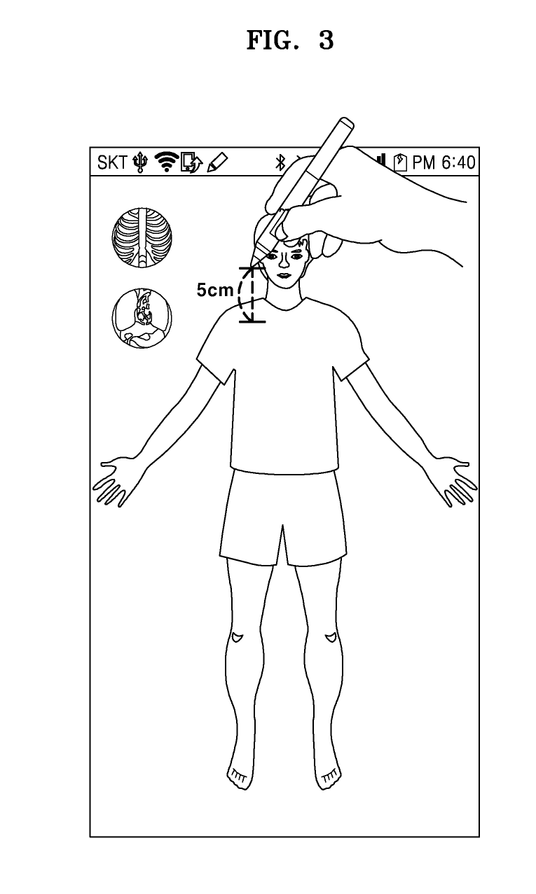

FIG. 3 illustrates a screen displayed on the terminal if the input tool is located within 5 cm of the terminal, according to an exemplary embodiment.

According to an exemplary embodiment, a user of the terminal 100 may move the input tool so that an end of the input tool is located within 5 cm of the terminal 100. For example, a length of a straight line extending in a perpendicular direction from the end of the input tool to the display unit 120 included in the terminal 100 may be 5 cm. Referring to FIG. 3, an image of a shoulder of the person wearing clothes which is included in the first content, displayed on the display unit 120, may be displayed at a point at which a straight line extending in a perpendicular direction from the end of the input unit to the display unit 120 included in the terminal 100 meets a surface of the display unit 120. A screen displayed when the input tool is located within 5 cm of the terminal 100 may not be different from the screen shown in FIG. 2. In other words, content displayed when the input tool is located within 5 cm of the terminal 100 may be identical to content displayed before information about a location of the input tool is detected by the input unit 110 or before an input is received from the input tool.

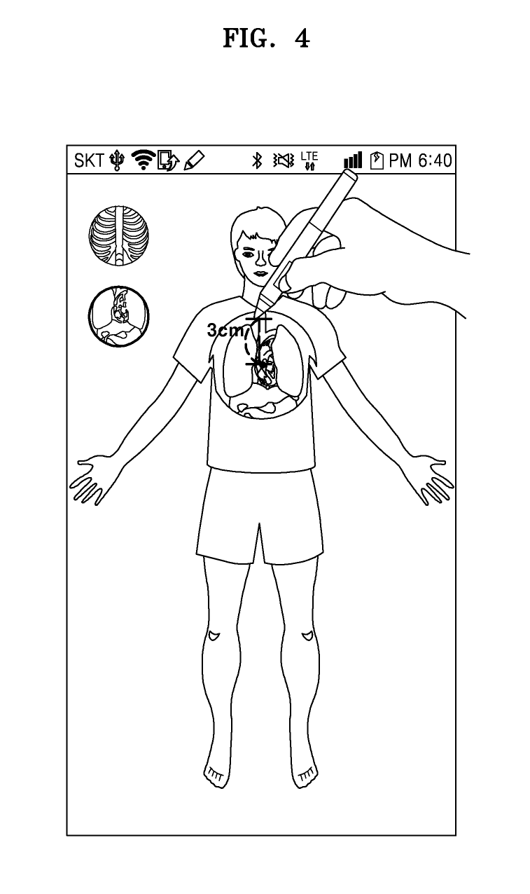

FIG. 4 illustrates a screen displayed on the terminal 100 if the input tool is located within 3 cm of the terminal 100, according to an exemplary embodiment. A user of the terminal 100 may move the input tool so that the end of the input tool is located within 3 cm of the terminal 100. For example, a length of a straight line extending in a perpendicular direction from the end of the input tool to the display unit 120 included in the terminal 100 may be 3 cm.

Referring to FIG. 4, a point at which a straight line extending in a perpendicular direction from the end of the input tool to the display unit 120 included in the terminal 100 meets a surface of the display unit 120, may correspond to an image of a chest of the person wearing clothes that is included in the first content displayed on the display unit 120. According to an exemplary embodiment, a screen displayed when the input tool is located within 3 cm of the terminal 100 may be different from a screen displayed before information about a location of the input tool is detected by the input unit 110 or before an input is received from the input tool. In other words, content displayed on the displayed unit 120 may be changed.

Referring to FIG. 4, when the input tool is located 3 cm above the terminal 100, second content that is an image of internal organs, may be displayed, instead of an image of a chest that is placed in a particular area of the person wearing clothes.

According to an exemplary embodiment, the same method may also be employed when the input tool is located within a specific range of distance from a side or a rear surface of the terminal 100.

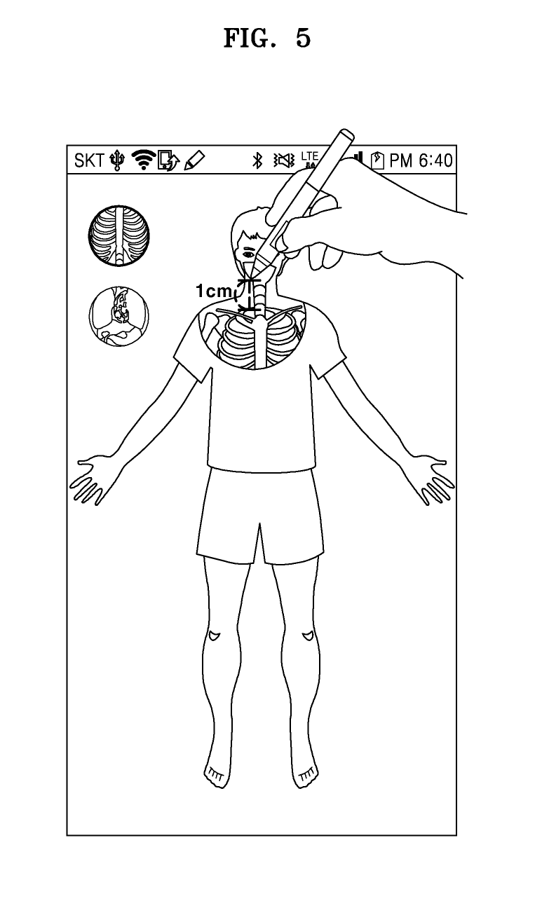

FIG. 5 illustrates a screen displayed on the terminal 100 if the input tool is located within 1 cm of the terminal 100, according to an exemplary embodiment. A user of the terminal 100 may move the input tool so that the end of the input tool is located within 1 cm of the terminal 100. For example, a length of a straight line extending in a perpendicular direction from the end of the input tool to the display unit 120 included in the terminal 100 may be 1 cm.

Referring to FIG. 5, a point, at which a straight line extending in a perpendicular direction from the end of the input unit to the display unit 120 included in the terminal 100 meets a surface of the display unit 120, may correspond to an image of a shoulder of the person wearing clothes included in the first content that is displayed on the display unit 120. A screen displayed when the input tool is located within 1 cm of the terminal 100 may be different from a screen displayed before information about a location of the input tool is detected by the input unit 110 or before an input is received from the input tool. Additionally, a screen displayed when the input tool is located 1 cm above the terminal 100 may be different from a screen displayed when the input tool is located 3 cm above the terminal 100.

Referring to FIG. 5, a screen displayed when the input tool is located 1 cm above the terminal 100 may display an image of internal bones included in second content, where the image relates to the shoulder included in the shoulder area of the person wearing clothes in the first content.

According to some exemplary embodiments, a particular area range of the first content may correspond to a particular area on the display unit 120 where a point at which a straight line extending in a perpendicular direction from an end of the input tool to the display unit 120 included in the terminal 100 meets a surface of the display unit 120.

The second content herein may refer to content that is different from the first content, and may be displayed together with the first content. The second content may include an image different from an image included in the first content, such as an image of a bone or an internal organ. Additionally, the second content displayed on the display unit 120 may vary according to a distance between the display unit 120 and the input tool.

In other words, according to an exemplary embodiment, the display unit 120 may display another screen or another content according to a distance in which the input tool is near the display unit 120. For example, when the display unit 120 displays the first content which is the image of the person wearing clothes, if the input tool is located within 3 cm of the display unit 120, the display unit 120 may display an image of internal organs within a particular area range of the first content based on a location of the input tool. Additionally, when the display unit 120 displays the first content which is the image of the person wearing clothes, if the input tool is located within 1 cm of the display unit 120, the display unit 120 may display an image of internal organs within a particular area range of the first content based on a location of the input tool.

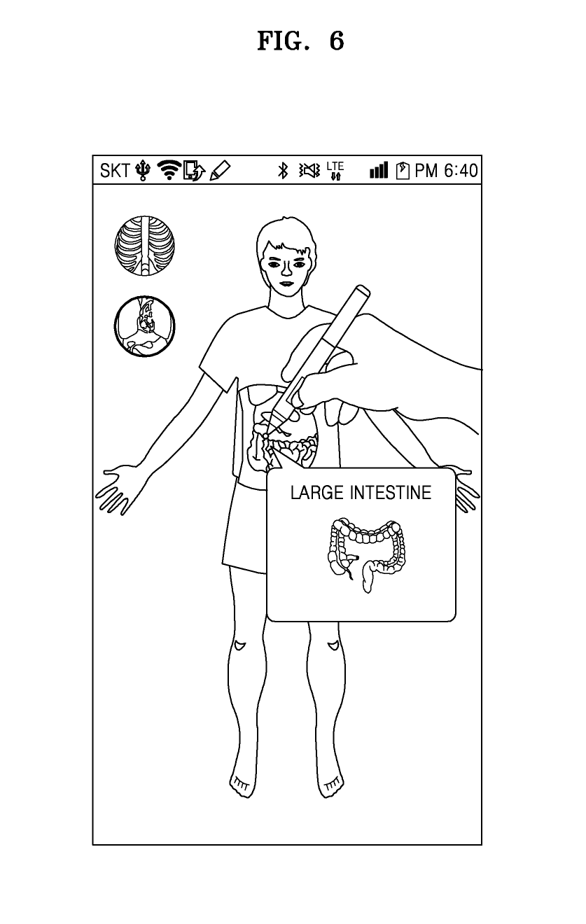

Additionally, if an amount of a change in a location of the input tool is less than a predetermined reference value for a predetermined period of time based on proximity information of the input tool, the control unit 140 may control the display unit 120 to display another content. This is described with reference to FIG. 6.

FIG. 6 illustrates a screen on which additional content is further displayed in a pop-up form, compared to the screen shown in FIG. 2, according to an exemplary embodiment.

According to an exemplary embodiment, a user of the terminal 100 may move the input tool so that an end of the input tool is located within 3 cm of the terminal 100. For example, a point, at which a straight line extending in a perpendicular direction from the end of the input tool to the display unit 120 included in the terminal 100 meets a surface of the display unit 120, may correspond to an abdomen of a person. The display unit 120 may display an image of internal organs with respect to the abdomen of the person wearing clothes included in the first content, according to a degree of proximity (e.g., how close or how far) of the input tool with respect to the display unit 120.

According to an exemplary embodiment, the input tool may not be moved for 3 seconds or more, or may be moved only within 0.5 cm of the terminal 100. If 3 seconds elapses, additional content regarding an organ at the end of the input tool point, from among displayed organs, may be displayed on the display unit 120. Referring to FIG. 6, an image of a large intestine, from among internal organs included in the second content, is displayed on an area of the abdomen which is a particular area of the first content (i.e., the first content being the image of the person wearing clothes). Additionally, an image of detailed information about internal organs (i.e., third content), with respect to the large intestine, may be further displayed in a pop-up form. According to an exemplary embodiment, content displayed by the terminal 100, may include audio content as well as visual content. According to an exemplary embodiment, audio content may be played by the speaker 130. For example, if the end of the input tool points at a heart from among internal organs which are displayed instead of a chest of the person wearing clothes, sound of a heartbeat may be played by the speaker 130.

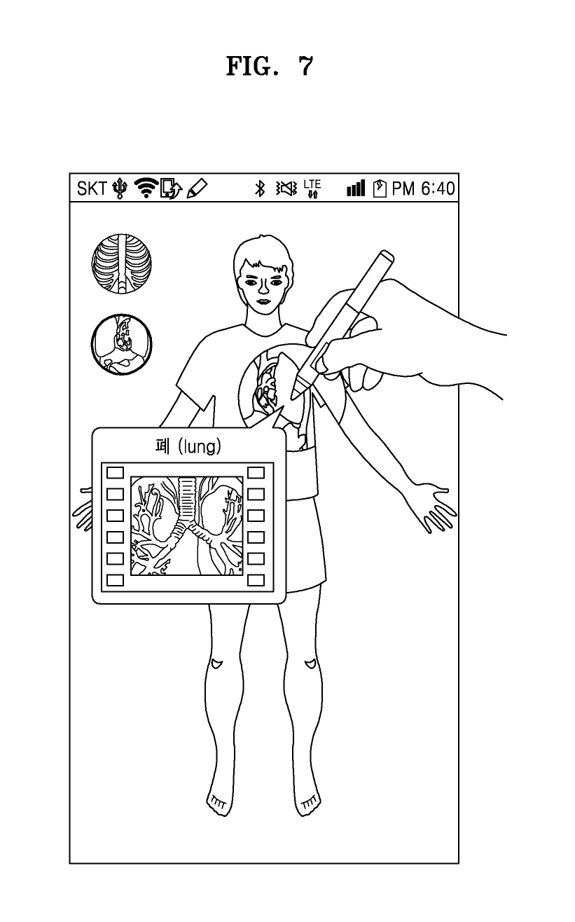

According to an exemplary embodiment, visual content may include a video clip. Visual content included in addition content may be displayed on the display unit 120, and audio content included in the additional content may be played by the speaker 130. For example, the control unit 140 may select an organ from an image of internal organs which is displayed on the display unit 120 instead of an image of a chest included in the first content showing the person wearing clothes. Then, if the selected organ is a lung, the control unit 140 may control the display unit 120 to play a video clip with information relating to the lung. FIG. 7 illustrates a screen on which a video clip is further displayed in a pop-up form, in addition to the screen shown in FIG. 2, according to an exemplary embodiment.

According to another exemplary embodiment, the control unit 140 may control the display unit 120 to display other content according to input information received from the input tool.

For example, a user of the terminal 100 may move the input tool so that an end of the input tool is located within 3 cm of the terminal 100. A point at which a straight line extending in a perpendicular direction from the end of the input tool to the display unit 120 included in the terminal 100 meets a surface of the display unit 120, may correspond to a chest of the person wearing clothes, where the person wearing clothes represents the first content displayed by the display unit 120. The display unit 120 may display an image of internal organs with respect to the chest of the person. The user of the terminal 100 may click a button included in the input tool. The control unit 140 may receive input information from the input tool by clicking the button of the input tool, and control, based on the input information, the display unit 120 to display additional content related to an internal organ at which the end of the input tool points, from among internal organs displayed. Referring to FIG. 7, third content that includes detailed information of the lung, that is, additional content related to the lung, in addition to the second content that is the image of internal organs, may be further displayed in an area of the chest of the person wearing clothes (the person wearing the clothes being the first content). The control unit 140 may determine whether to display the second content based on the input information received from the input tool.

According to an exemplary embodiment, the control unit 140 may control the display unit 120 to display other content, according to a touch input received from the input tool.

For example, a user may move the input tool so that an end of the input tool is located within 3 cm of the terminal 100. A point at which a straight line extending in a perpendicular direction from the end of the input tool to the display unit 120 included in the terminal 100 meets a surface of the display unit 120, may correspond to an image of a chest of the person wearing clothes (the person wearing the clothes being the first content). Additionally, the display unit 120 may display the second content, which is the image of the internal organs, with respect to the chest of the person wearing clothes.

The user of the terminal 100 may touch a lung in the displayed second content, which is the image of the internal organs, by using the input tool. The control unit 140 may control the display unit 120 to display the third content which includes additional content related to the touched organ, in the image of the internal organs. In other words, referring to FIG. 7, the terminal 100 may further display additional content related to the lung, by selecting, using the input tool, from the image of the internal organs, which is displayed instead of a chest of the person wearing clothes in a pop-up form.

Additionally, according to an exemplary embodiment, the control unit 140 may control the display unit 120 to display a screen by using information obtained or detected by the input unit 110, and then, display another screen by using information further received or detected by the input unit 110.

For example, when the screen shown in FIG. 7 is displayed, the user may move the end of the input tool to point at video clip content. After the end of the input tool is moved, the control unit 140 may control the display unit 120 to display another content if an amount of a change in a location of the input tool is equal to or less than a predetermined reference value for a predetermined period of time.

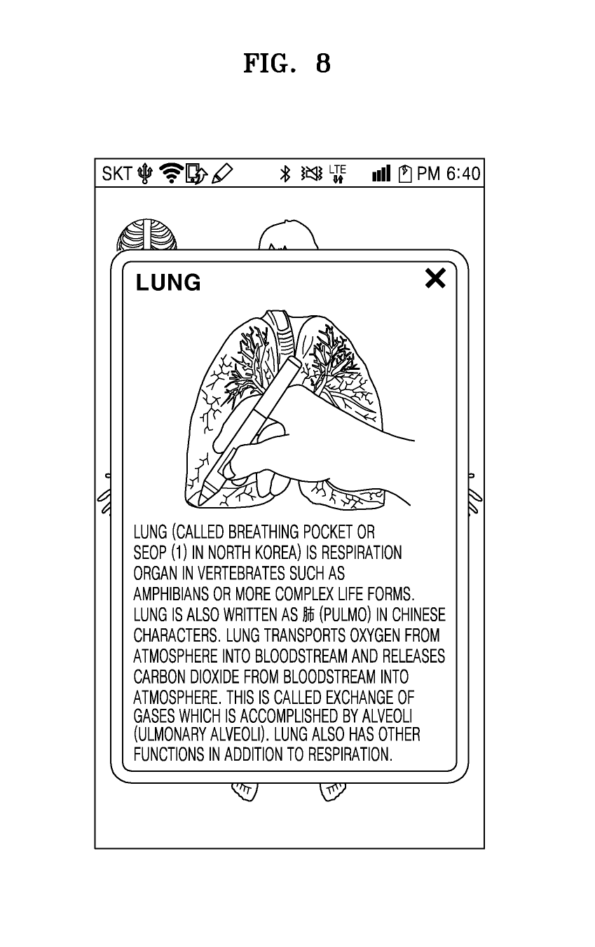

For example, if the input tool is not moved for 3 seconds, the display unit 120 may display a detailed description of the lung. FIG. 8 illustrates a screen of the terminal 100 on which new content is displayed after a video clip content is displayed as additional content.

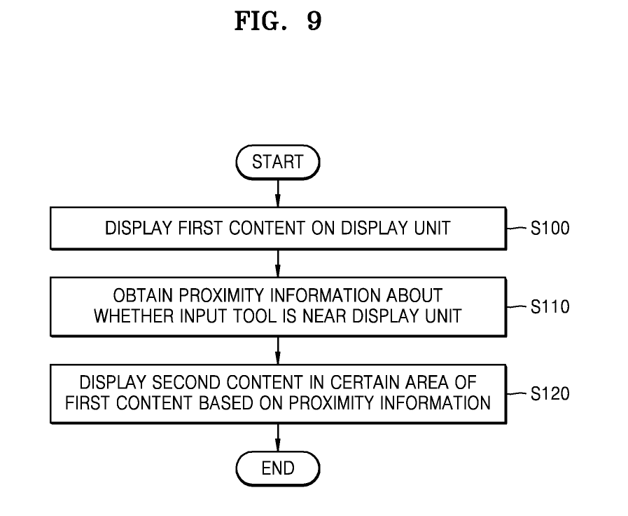

FIG. 9 is a flowchart of a process of performing a content displaying method, which is performed by the terminal 100, according to an exemplary embodiment. Referring to FIG. 9, in operation S100, the display unit 100 may display first content. The control unit 140 may display a screen on the display unit 120 as shown in FIG. 2 by controlling the display unit 120.

In operation S110, the input unit 110 included in the terminal 100 may obtain proximity information about whether the input tool is near the terminal 100. The proximity information may include information about whether the input tool is present within a specific range of distance from the terminal 100, and information about whether the input tool is located above the display unit 120 or within a specific distance range above the display unit 120. This corresponds to a description provided with reference to FIG. 1, and thus, a description thereof is not provided here.

In operation S120, the terminal 100 may display second content on a particular area of the first content, based on the proximity information.

Additionally, according to an exemplary embodiment, the terminal 100 may select the second content from among the group consisting of a plurality of pieces of content, according to a degree of proximity of the input tool to the terminal 100, and display the first content and the selected second content together.

For example, referring to FIGS. 4 and 5, the control unit 140 may select one piece of content selected from the group consisting of displayed content having an image of internal organs or displayed content having an image of bones, according to a degree of proximity of the input tool to the terminal 100. If the input tool is located 3 cm above the terminal 100, the control unit 140 may select the displayed content having the image of the internal organs. If the input tool is located 1 cm above the terminal 100, the control unit 140 may select the displayed content having the image of the bones.

Additionally, according to an exemplary embodiment, the display unit 120 may display third content which is different from the first content and the second content. The control unit 140 may display the third content on the display unit 120 by controlling the display unit 120. For example, the control unit 140 may display the third content if an amount of a change in a location of the input tool for a predetermined period of time is equal to or less than a predetermined reference value. Alternatively, the control unit 140 may display the third content based on a touch input by the input tool or input information received from the input tool.

Additionally, according to an exemplary embodiment, the terminal 100 may display the first content, the second content, and the third content based on whether the input tool is near the terminal 100, a degree of proximity of the input tool to the terminal 100, and an amount of a change in a location of the input tool. This corresponds to the description provided with reference to FIGS. 1 to 8, and thus, a description thereof is not provided here.

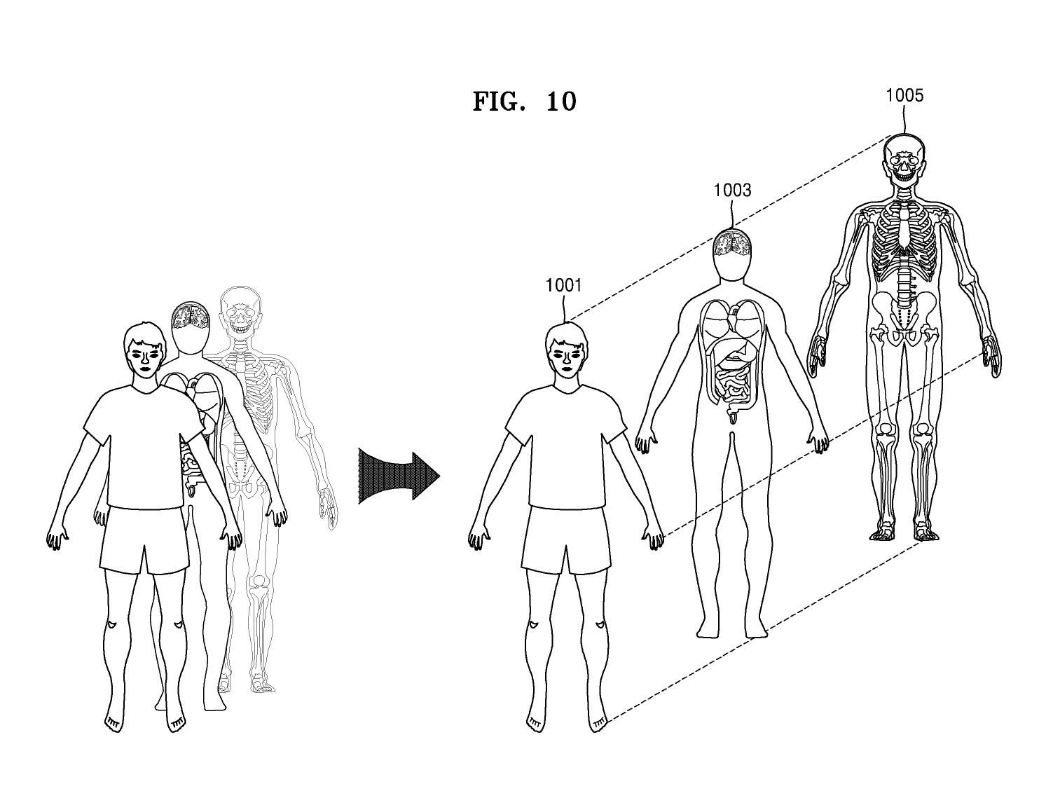

FIG. 10 illustrates content formed of a plurality of layers, according to some exemplary embodiments.

According to exemplary embodiments, content may be formed of a plurality of layers. Referring to FIG. 10, first content 1001, which is an image of a person wearing clothes, may constitute an uppermost layer, second content 1003, which is an image of internal organs may constitute a first lower layer, and third content 1005, which is an image of bones, may constitute a second lower layer.

Additionally, referring to FIG. 10, layers constituting content may be respectively the first content 1001, the second content 1003, and the third content 1005. In other words, the first content 1001, the second content 1003, and the third content 1005 which are constituted by each layer may constitute one piece of content in a layered structure.

According to an exemplary embodiment, in a method of displaying content formed of a plurality of layers, a terminal 100 may display only content that constitutes an uppermost layer. Alternatively, as shown in a left-side drawing shown in FIG. 10, whole content (e.g., full image) may be displayed in an uppermost layer, and only a part of content may be displayed in lower layers. Additionally, according to an exemplary embodiment, the terminal 100 may display the first content 1001. If the input tool is not near the terminal 100, the terminal 100 may display only the first content 1001, and may not display the second content 1003 and the third content 1005. According to some exemplary embodiments, the terminal 100 may perform rendering to display lower layers before displaying content.

According to some exemplary embodiments, the additional content described with reference to FIG. 7 may constitute a layer. In other words, additional content such as a link for providing a description and related information about internal organs such as a lung or a heart, link information about an image and sound, or a description about internal bones may constitute a layer. A layer constituted by additional content may be displayed based on proximity information of the input tool, like the first to third content.

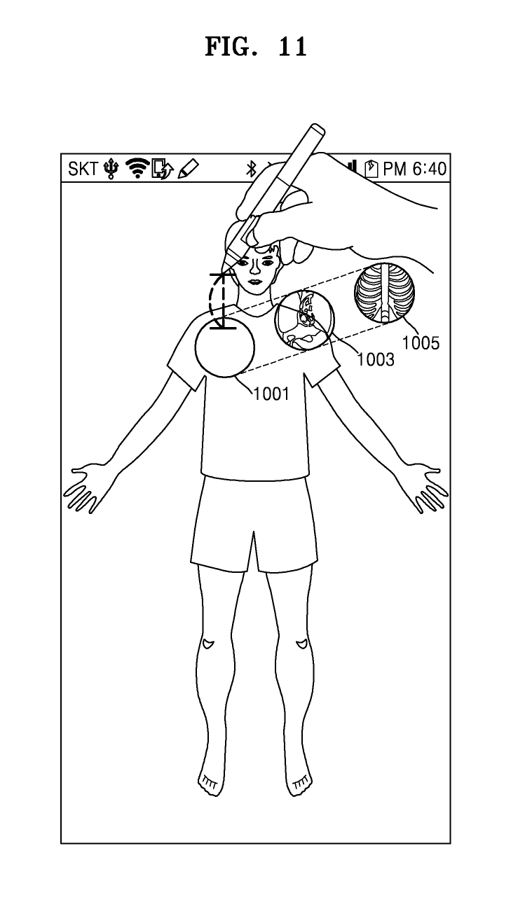

According to some exemplary embodiments, the terminal 100 may determine a layer to be displayed, based on proximity information of the input tool. This is described in detail with reference to FIG. 11.

FIG. 11 illustrates a screen on which content formed of a plurality of layers is displayed according to proximity information, according to this exemplary embodiments.

Referring to FIG. 11, the input tool may determine a layer to be displayed based on proximity information with respect to the terminal 100.

For example, if the input tool is located at a first height, the terminal 100 may display an image of internal organs which is the second content 1003 provided in a first lower layer, instead of an image of a chest which is located within a particular area of the first content 1001 provided in an uppermost layer.

If the input tool is located at a second height, the terminal 100 may display an image of internal bones which is the third content 1005 provided in a second lower layer, instead of an image of the chest which is located within a particular area of the first content 1001 provided in the uppermost layer.

According to an exemplary embodiments, the terminal 100 may not display the first content 1001, and may display the second content 1003 that is provided on the first lower layer or the third content 1005 that is provided on the second lower layer, based on proximity information of the input tool.

According to some exemplary embodiments, based on proximity information of the input tool, the terminal 100 may display at least one selected from the group consisting of the first content 1001, the second content 1003, and the third content 1005 in correspondence with a distance of a line from a point at which the straight line, extending in a perpendicular direction from an end of the input tool to the display unit 120 included in the terminal 100, meets a surface of the display unit 120.

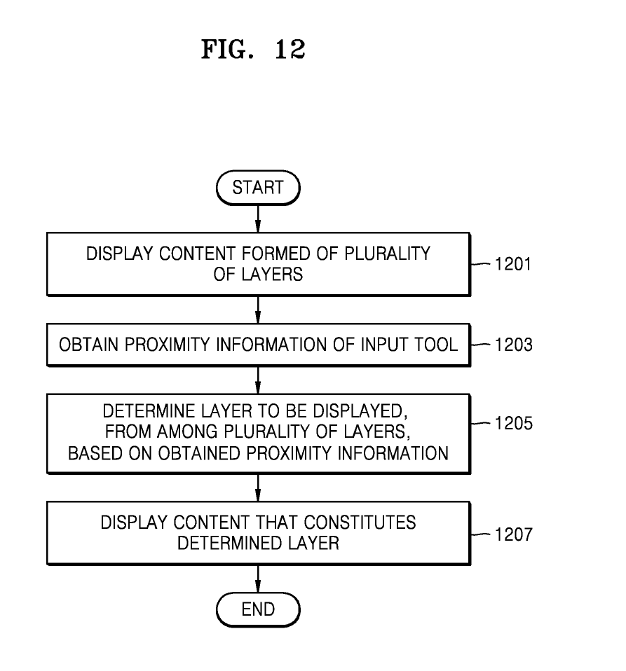

FIG. 12 is a flowchart of a method of displaying, according to proximity information, pieces of content formed of a plurality of layers, according to some exemplary embodiments.

In operation 1201, the terminal 100 may display pieces of content formed of a plurality of layers.

According to some exemplary embodiments, the terminal 100 may display only content that constitutes an uppermost layer from among the pieces of content formed of the plurality of layers. Additionally, the terminal 100 may display all content that respectively constitutes the plurality of layers, in parallel or simultaneously.

In operation 1203, the terminal 100 may obtain proximity information of the input tool.

According to some exemplary embodiments, the proximity information may include information about whether the input tool is present within a specific distance from the terminal 100, and may include information about whether the input tool is located above the display unit 120 or within a specific distance above the display unit 120. This corresponds to the description provided with reference to FIG. 1, and thus, a description thereof is not provided here.

In operation S1205, the terminal 100 may determine a layer to be displayed from among the plurality of layers, based on the obtained proximity information.

In other words, the terminal 100 may determine a layer to be displayed from among the plurality of layers that constitute content, based on the proximity information obtained from the input tool, by mapping a distance between the input tool and the terminal 100 with the layer to be displayed. In operation 1207, the terminal 100 may display content that constitutes the layer that is determined to be displayed.

According to some exemplary embodiments, the terminal 100 may display content that constitutes a lowermost layer when the distance between the display unit 120 included in the terminal 100 and the input tool is short. Alternatively, the terminal 100 may display content that constitutes a lower layer when the distance between the display unit 120 included in the terminal 100 and the input tool is long.

Alternatively, according to some exemplary embodiments, when a distance between the display unit 120 included in the terminal 100 and the input tool is short, the terminal 100 may further display content that constitutes an upper layer.

According to the exemplary embodiments described above, content may be provided intuitively. Additionally, a screen may be displayed or sound may be played by simply performing basic manipulations.

As described above, according to the one or more of the above exemplary embodiments, content may be provided intuitively.

In addition, other exemplary embodiments can also be implemented through computer-readable code/instructions in/on a medium, e.g., a computer-readable medium, to control at least one processing element to implement any above described exemplary embodiment. The medium can correspond to any medium/media permitting the storage and/or transmission of the computer-readable code.

The computer-readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as Internet transmission media. Thus, the medium may be such a defined and measurable structure including or carrying a signal or information, such as a device carrying a bitstream according to one or more exemplary embodiments. The media may also be a distributed network, so that the computer-readable code is stored/transferred and executed in a distributed fashion. Furthermore, the processing element could include a processor or a computer processor, and processing elements may be distributed and/or included in a single device.

The apparatus described herein may include a processor, a memory for storing program data and executing it, a permanent storage such as a disk drive, a communications port for handling communications with external devices, and user interface devices, including a display, keys, etc.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the inventive concept, reference has been made to the exemplary embodiments illustrated in the drawings, and specific language has been used to describe these embodiments. However, no limitation of the scope of the inventive concept is intended by this specific language, and the inventive concept should be construed to encompass all embodiments that would normally occur to one of ordinary skill in the art.

The inventive concept may be described in terms of functional block components and various processing steps. Such functional blocks may be realized by any number of hardware and/or software components configured to perform the specified functions. For example, the inventive concept may employ various integrated circuit components, e.g., memory elements, processing elements, logic elements, look-up tables, and the like, which may carry out a variety of functions under the control of one or more microprocessors or other control devices. Similarly, where the elements of the inventive concept are implemented using software programming or software elements the inventive concept may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the inventive concept could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the inventive concept and are not intended to otherwise limit the scope of the inventive concept in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the inventive concept unless the element is specifically described as “essential” or “critical”.

The use of the terms “a” and “an” and “the” and similar referents in the context of describing the inventive concept (especially in the context of the following claims) are to be construed to cover both the singular and the plural. Furthermore, recitation of ranges of values herein are merely intended to function as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the inventive concept and does not pose a limitation on the scope of the inventive concept unless otherwise claimed. Additionally, it will be understood by those of ordinary skill in the art that various modifications, combinations, and changes can be formed according to design conditions and factors within the scope of the attached claims or the equivalents.

It should be understood that the exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

1. A terminal comprising:
an input unit configured to obtain proximity information related to a proximity of an input tool to first content displayed on the terminal;
a controller configured to control a display to display second content on an area of the first content, based on the proximity information; and
the display configured to display the first content and the second content, based on the proximity information.

2. The terminal of claim 1, wherein the controller is configured to determine whether the input tool is located within a range of distance from the display and is configured to control the display to display the second content on the area of the first content based on the determination of whether the input tool is located within the range of distance from the display.

3. The terminal of claim 1, wherein the proximity information comprises information related to a location of the input tool, and
wherein the controller is configured to control the display to display the second content to overlap with the first content in the area of the first content, based on the location of the input tool.

4. The terminal of claim 3, wherein the proximity information further comprises information related to a degree of proximity of the input tool to the terminal, and
wherein the controller is configured to control the display to display the second content on the area of the first content based on the information related to the degree of the proximity.

5. The terminal of claim 4, wherein the controller is configured to select the second content from among a plurality of pieces of content, based on the information related to the degree of the proximity.

6. The terminal of claim 3, wherein the controller is configured to compare an amount of a change in the location of the input tool for a period of time to a reference value, based on the proximity information, and is configured to control the display to display third content on the area of the first content, based on a result of the comparing the amount of the change in the location of the input tool for the period of time to the reference value.

7. The terminal of claim 6, wherein the first, second, and third content respectively comprise at least one from among a text, a drawing, a picture, and a video clip.

8. The terminal of claim 1, wherein the controller is configured to control the display to display third content on another area of the first content, based on input information received from the input tool.

9. The terminal of claim 1, wherein the input unit is configured to detect a touch input by the input tool, and
the controller is configured to control the display to display third content in another area of the first content, according to the touch input.

10. The terminal of claim 4, wherein the information related to the location of the input tool comprises information related to a location of a point at which a straight line extending in a perpendicular direction from an end of the input unit to the display meets a surface of the display, and
the controller is configured to control the display by using the information related to the location of the point at which the straight line extending in the perpendicular direction from the end of the input unit to the display meets the surface of the display and the information related to the degree of proximity of the input tool to the terminal.

11. The terminal of claim 1, further comprising a speaker configured to play sound,
wherein the controller is configured to control the speaker by using the proximity information.

12. A method of displaying content, the method being performed by a terminal and the method comprising:
displaying first content on a display;
obtaining proximity information related to a proximity of an input tool to the first content displayed on the display; and
displaying second content on an area of the first content based on the proximity information.

13. The method of claim 12, wherein the displaying the second content comprises determining whether the input tool is located within a range of distance from the display; and
displaying the second content in the area of the first content based on the determination of whether the input tool is located within the range of distance from the display.

14. The method of claim 12, wherein the proximity information comprises information related to a location of the input tool, and
the displaying the second content comprises displaying the second content to overlap with the first content in the area of the first content, based on the location of the input tool.

15. The method of claim 14, wherein the proximity information further comprises information related to a degree of proximity of the input tool to the terminal, and
the displaying the second content comprises displaying the second content to overlap with the first content in the area of the first content, based on the information related to the degree of the proximity.

16. The method of claim 15, wherein the displaying the second content further comprises selecting the second content from among a plurality of pieces of content, based on the information related to the degree of the proximity.

17. The method of claim 14, wherein the displaying the second content further comprises comparing an amount of a change in the location of the input tool for a period of time to a reference value, based on the proximity information; and
displaying third content on another area of the first content, based on a result of the comparing.

18. The method of claim 12, wherein the first content, the second content, and the third content respectively comprise at least one from among a text, a drawing, a picture, and a video clip.

19. The method of claim 12, further comprising:
receiving input information from the input tool; and
displaying third content on another area of the first content, based on the received input information.

20. The method of claim 12, further comprising:
detecting a touch input by the input tool, and
displaying third content on another area of the first content, according to the touch input.

21. The method of claim 14, wherein the information related to the location of the input tool comprises information related to a location of a point at which a straight line extending in a perpendicular direction from an end of the input tool to the display meets a surface of the display, and
the displaying the second content further comprises displaying the second content on the area of the first content by using the information related to the location of the point at which a straight line extending in a perpendicular direction from the end of the input unit to the display meets a surface of the display and the information related to the degree of the proximity of the input tool to the terminal.

22. The method of claim 12, further comprising controlling a speaker, comprised in the terminal, by using the proximity information.

23. A non-transitory computer-readable recording storage medium having stored thereon a computer program, which when executed by a computer, performs the method of claim 12.

24-32. (canceled)
